(19) United States
(12) Patent Application Publication
(10) Pub. No.: US 2020/0208036 A1
(43) Pub. Date: Jul. 2, 2020

(54) COMPOSITE THERMAL INTERFACE MATERIALS, THERMAL INTERFACE COMPONENTS, AND METHODS FOR MAKING THE SAME

(71) Applicant: Intel Corporation, Santa Clara, CA (US)

(72) Inventor: PAUL GWIN, Orangevale, CA (US)

(73) Assignee: Intel Corporation, Santa Clara, CA (US)

(21) Appl. No.: 16/817,423

(22) Filed: Mar. 12, 2020

Related U.S. Application Data
(62) Division of application No. 15/717,752, filed on Sep. 27, 2017.

(51) Int. Cl. C09K 5/14; C08K 3/08; B32B 27/20; B32B 27/12; B32B 27/38; B32B 27/08; B32B 5/02; B32B 3/30; C08K 3/04; C08K 3/22; C08K 3/38

(52) U.S. Cl. CPC C09K 5/14; B32B 2264/102; B32B 27/20; B32B 27/12; B32B 27/38; B32B 27/08; B32B 5/02; B32B 3/30; C08K 3/042; C08K 3/04; C08K 3/22; C08K 3/38; B32B 2264/108; B32B 2264/107; B32B 2264/105; B32B 2307/302; B32B 2260/046; B32B 2260/021; C08K 2003/2227; C08K 2003/385; C08K 2003/0862; C08K 2003/0806; C08K 3/08

(57) ABSTRACT

Technologies for facilitating the transfer of heat from a first location to a second location. In embodiments, the technologies include composite thermal interface materials, thermal interface components, and methods for making such composites and components. The thermal interface materials may include a core including a first b-stage matrix and first thermally conductive particles, and a skinning layer including a second b-stage matrix and second thermally conductive particles. The thermal interface components may be formed from or include the composite thermal interface material, and may include one or more convex surfaces.

### TECHNICAL FIELD

The present disclosure relates to technologies for facilitating the transfer of heat from a first location to a second location. In particular, the present disclosure relates to composite thermal interface materials, thermal interface components including such materials, and methods for making such composites and components.

### BACKGROUND

Transferring heat from one location to another is a common technical challenge in many industries. In the electronics industry, for example, transferring heat generated by the operation of microelectronic devices such as processor chips, memory chips, and other devices is often needed to ensure that such devices function properly. Such components are often designed to operate within a specific thermal envelope, and the probability that they will malfunction generally increases as the temperature at which they are operated increases.

Sophisticated thermal management solutions have been developed to facilitate the transfer of heat away from sensitive microelectronic components. Some of those solutions utilize a thermal transfer unit such as a heat sink, heat spreader, heat pipe, etc., to transfer heat from one from location (e.g., an electronic component) to a another location (e.g., air, a liquid, etc.). Many thermal transfer units include a contact surface that is formed from one or more high thermal conductivity materials. The contact surface may be attached to a corresponding surface of a heat generating component in such a way as to facilitate the transfer of heat away from that component. For example, some thermal transfer units include a plate that is formed from a high thermal conductivity material, and which is designed to couple to a surface of a microelectronic component such as a processor. As heat is generated by the microelectronic component it is transferred into the plate and ultimately transferred to another medium.

The contact surface of thermal transfer unit and the corresponding surface of a heat generating component (to which the contact surface is to be coupled) are rarely perfectly flat. As a result, voids containing air are can be present between the contact surface of a thermal transfer unit and a corresponding surface of a heat generating component. As air is a thermal insulator, such voids can increase thermal interface resistance at the interface between such surfaces. This can limit the ability of the heat transfer unit to remove heat from the heat generating component. To address that issue, thermal interface materials such as thermally conductive polymers, thermal pastes, thermal greases, etc., have been developed to facilitate the transfer of heat from a heat generating component to a thermal transfer unit. Such compositions may function to reduce thermal interface resistance at an interface between the contact surface of the thermal transfer unit and a corresponding surface of the heat generating component.

Although existing thermal interface materials can effectively improve the transfer of heat from a heat generating component to a thermal transfer unit, they can suffer from one or more drawbacks that make them unsuitable or undesirable for some applications. For example, some thermal interface materials may have relatively low viscosity, and therefore may be difficult to apply with precision. For example, low viscosity thermal greases tend to be runny, and may be difficult to apply to a surface of a heat generating component without running off that surface or creating air pockets that increase thermal resistance. Thermal interface pads may not suffer from that issue, as they are pre-cured. However they may not adhere well to components to which they are applied and they may have low modulus, making them undesirable for some applications. Phase change thermal interface materials can lose their properties at elevated temperatures and are subject to drying out, which may also make them unsuitable for some applications. Moreover, some existing thermal interface materials are unable to conform to significantly curved surfaces without the development of air containing gaps that can result in increased thermal interface resistance.

Accordingly, there remains an interest in the development of new and useful thermal interface materials and thermal interface components that include such materials.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 is a cross-sectional diagram of one example of a composite thermal interface material, consistent with the present disclosure;

FIG. 2 is a cross-sectional diagram of one example of a composite thermal interface material that includes a fabric reinforcement, consistent with the present disclosure;

FIGS. 3A-3D are cross-sectional diagrams of example composite thermal interface materials that include one or more fabric reinforcements, consistent with the present disclosure;

FIGS. 4A-4C are cross sectional diagrams of one example of a three-dimensional thermal interface component consistent with the present disclosure;

FIG. 5 is a cross-sectional diagram of another example of a three-dimensional thermal interface component consistent with the present disclosure.

FIGS. 6A and 6B are cross sectional diagrams of yet another example of a three-dimensional thermal interface component consistent with the present disclosure.

### DETAILED DESCRIPTION

While the present disclosure is described herein with reference to illustrative embodiments for particular applications, it should be understood that such embodiments are exemplary only and that the invention as defined by the appended claims is not limited thereto. Those skilled in the relevant art(s) with access to the teachings provided herein will recognize additional modifications, applications, and embodiments within the scope of this disclosure, and additional fields in which embodiments of the present disclosure would be of utility.

As used herein, the term “about” when used in connection with a value means plus or minus 5% of the indicated value. When used in the context of a range, the term “about” is used herein to refer to plus or minus 5% of the endpoints of the indicated range.

As used herein, the term “substantially” when used in connection with an orientation of an axis or a plane means plus or minus 10 degrees of the indicated orientation. By way of example, the term “substantially coplanar” when used to describe the relationship of two points or features means that the indicated points or features are on the same plane or axis as one another, or are disposed within plus or minus 10 degrees of the indicated plane or axis. Accordingly, two points or features may be substantially coplanar with regard to a horizontal axis/plane if they are disposed within plus or minus 10 degrees of the horizontal axis/plane.

From time to time the present disclosure describes the amount of a component or the scale of an indicated property using one or more ranges. It should be understood that the indicated ranges are inclusive of the indicated endpoints. Moreover, such ranges should be understood to include any and all sub-ranges within the indicated endpoints, as though those sub-ranges were expressly recited. Thus, a range of 1 to 10 should be understood to include all sub-ranges therein, e.g., 2 to 10, 2 to 9, 2 to 8, 3 to 9, etc., as though such sub-ranges were expressly stated.

As used herein, the term “and/or,” when used in connection with multiple features means one of the stated features, a combination of a subset of the state features, or a combination of all of the state features. For example, a statement that a component includes features A, B, and/or C means that the component includes feature A, B, or C, a combination of features A and B (but not C), a combination of features B and C (but not A), a combination of features A and C (but not B), or a combination of features A, B, and C.

As used herein, the term “adherent” refers to an article (or a surface of an article) to which a composite thermal interface material (composite TIM) or a three dimensional thermal interface component (3D TIC) consistent with the present disclosure is attached or is to be attached.

As used herein, the term “b-stage” refers to a partially cured (crosslinked) polymer composition. For example, a b-stage epoxy is an epoxy polymer that has been partially cured/crosslinked, e.g., using a latent (low reactivity) curing agent, light, and/or heat. Such a composition may be fully cured at a later time, e.g., by the application of light (e.g., ultraviolet light), elevated temperature, and/or in conjunction with elevated pressure. In embodiments, b-stage polymers described herein include or are formed from a thermoset polymer that has been cured/crosslinked to about 5 to about 15% of full cure/crosslinking. A b-stage material may also be understood to be a polymer composition that has been cured to the point at which it can retain a desired shape for storage, handling, and assembly.

As used herein the term “on” when used to describe the positional relationship of a first component/element to a second component/element means that the first component is above the second component/element, but is not necessarily in contact with a surface of the second component/element. In contrast, the term “directly on” is used herein to mean that the first component/element is disposed above and in contact with the surface of a second component/element.

With the foregoing in mind, the present disclosure generally relates to technologies for facilitating the transfer of heat away from a heat generating component, such as a microelectronic device, a heat sink, or the like. In that regard, aspects of the present disclosure relate to composite thermal interface materials (composite TIMS) that include a core having a first surface and a second surface. A first skinning layer is on the first surface of the core. In embodiments, the core includes a first b-stage polymer matrix and first thermally conductive materials, and the first skinning layer includes a second b-stage polymer matrix, and second thermally conductive particles. Three-dimensional (3D) thermal interface components (3D TICs) and methods of making the same are also described. In embodiments the composite TIMs and 3D TICs described herein exhibit various desirable properties, such as relatively high bond strength, long working life, relatively easy handling and installation, the ability to conform and bond to significantly curved surfaces, and/or simple production.

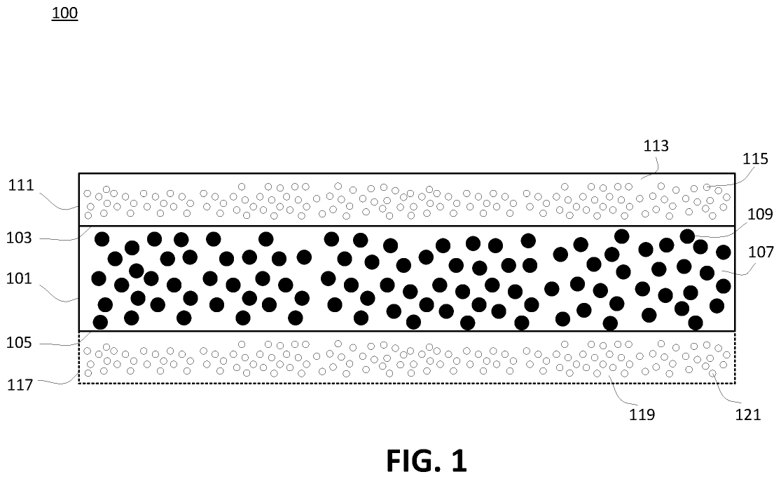

FIG. 1 illustrates one example of a composite TIM consistent with the present disclosure. As shown, the composite TIM 100 includes a core 101 having a first (upper) surface 103 and second (lower) surface 105. A first skinning layer 111 is disposed on the first surface 103 of the core 101. In embodiments and as shown in FIG. 1 (and various other FIGS), the composite TIM 100 may also include an optional second skinning layer 117, which may be disposed below the core 101. Put differently, the core 101 may be disposed on (e.g., directly on) the optional second skinning layer 117, such that the second surface 105 is above or in direct contact with the optional second skinning layer 117.

In embodiments the composition and properties of the core 101 and the skinning layer(s) 111, 117 may be tailored such that the composite TIM is suitable for certain applications. For example, in embodiments the core 101 is configured to exhibit relatively high thermal conductivity, but may also exhibit relatively high thermal interface resistance compared to the skinning layer(s) 111, 117. In contrast, the skinning layer(s) 111, 117 may be configured to exhibit lower thermal interface resistance, but also lower thermal conductivity compared to the core 101. The relatively low thermal interface resistance of the skinning layer(s) 111, 117 can mitigate the relatively high thermal interface resistance of the core 101, thus facilitating the transfer of heat into the core from an adherent to which the composite TIM is attached.

As further shown in FIG. 1, the core 101 includes a first matrix 107 and first thermally conductive particles 109. Generally, the first matrix 107 serves to host and bind the first thermally conductive particles 109, and the first thermally conductive particles 109 function to adjust the thermal properties of the core 101. For example, the first matrix 107 may be selected to impart desired physical properties to the core 101, such as tensile strength, adhesion strength (to one or more adherents and/or the first and/or second skinning layers 111, 117), a desired degree of drape and/or bendability, combinations thereof, and the like. The core 101 may also retain is shape more than the skinning layers 111, 117, so that in assembly the skinning layer(s) flow to create a low thermal interface resistance, while the inner core 101 conforms in shape but retains its properties. In contrast, the first thermally conductive particles 109 may be selected to impart desired thermal properties to the core 101, such as thermal conductivity, low thermal interface resistance, combinations thereof, and the like. The core 101 may also include a high concentration and/or packing density of thermally conductive particles than the skinning layers(s) 111, 117. The relatively high concentration of thermally conductive particles in the core 101 can increase its thermal conductivity, without compromising the relatively low thermal contact resistance of the skinning layer(s) 111, 117. In that regard, in some embodiments the core 101 is formulated to exhibit a thermal conductivity, thermal interface resistance, tensile strength, and/or viscosity that are greater than the corresponding properties of the first skinning layer 111 and, when used, the corresponding properties of the second skinning layer 117.

The first matrix 107 may be formed from any suitable matrix material. Non-limiting examples of suitable materials that may be used as or in the first matrix 107 include polymeric materials, such as by not limited to epoxy resins, acrylate resins, phenolic resins, polysiloxane resins, organo-functionalized polysiloxane resins, polyimide resins, polyester resins, vinyl ester resins, combinations thereof, and the like. Without limitation, in embodiments the first matrix 107 is a b-stage of one or more of the foregoing polymer compositions. For convenience, such a matrix is referred to herein as a “b-stage polymer matrix.” In embodiments, the first matrix 107 is a b-stage polymer matrix of a thermoset polymer composition, wherein the thermoset polymer composition has been lightly crosslinked (e.g., with a curing agent, heat, and/or pressure) prior to application to an object such as a surface of a heat generating component. In specific non-limiting embodiments, the first matrix is a b-stage of one or a combination of the foregoing polymer compositions and, in some instances, is a b-stage epoxy. Non-limiting examples of suitable b-stage epoxies include b-stage resins of the epoxy resin systems sold under the trade names EPON™ 828, EPON™ 826, and EPON™ 815 by HEXION™. In embodiments, the first matrix 107 is a b-stage epoxy that has been cured to a crosslink density of about 5 to about 15% of the crosslink density of composition as fully cured.

The first thermally conductive particles 109 are particles of one or more thermally conductive materials and, in particular, of one or a combination of thermally conductive materials that have a bulk thermal conductivity greater than the thermal conductivity of the first matrix 107. Thus, in some embodiments the first matrix 107 may exhibit a thermal conductivity TC1 and the first thermally conductive particles 109 may be formed from a material having a first bulk thermal conductivity BTC1, wherein BTC1 is greater than TC1. In some embodiments, the first thermally conductive particles comprise particles of at least one material that has a bulk thermal conductivity (BTC) greater than or equal to about 4 Wm⁻¹K⁻¹, such as greater than or equal to about 10 Wm⁻¹K⁻¹, greater than or equal to about 20 Wm⁻¹K⁻¹, or even greater than or equal to about 40 Wm⁻¹K⁻¹. As a result, the first thermally conductive particles 109 generally function to increase the thermal conductivity of the core 101 above the thermal conductivity of the first matrix 107. In some embodiments the first thermally conductive particles are selected such that the core 101 exhibits a thermal conductivity and thermal interface resistance that is greater than the thermal conductivity and thermal interface resistance of the first skinning layer 111 and, when used, the second skinning layer 117. Without limitation, in embodiments the thermal conductivity of the core 101 ranges from greater than 1 to about 30 Wm⁻¹K⁻¹, such as from greater than 1 to about 15 Wm⁻¹K⁻¹, greater than 1 to about 10 Wm⁻¹K⁻¹, or even from greater than 1 to about 7 Wm⁻¹K⁻¹

Non-limiting examples of suitable materials that may be used as or in the first thermally conductive particles 109 include metals, metal oxides and metal nitrides, such as but not limited to copper (Cu; BTC of about 401 Wm⁻¹K⁻¹), gold (Au; BTC of about 310 Wm⁻¹K⁻¹), nickel (Ni; BTC of about 91 Wm⁻¹K⁻¹), silver (Ag; BTC of about 429 Wm⁻¹K⁻¹), aluminum oxide (Al₂O₃; BTC ranging from about 12-38.5 Wm⁻¹K⁻¹)), aluminum nitride (BTC ranging from about 17 Wm⁻¹K⁻¹ to 285 Wm⁻¹K⁻¹), titanium oxide (TiO₂; BTC ranging from about 4.8-11.8 Wm⁻¹K⁻¹), titanium nitride (TiN; BTC of about 28.8 Wm⁻¹K⁻¹), zinc oxide (BTC of about 40 Wm⁻¹K⁻¹), yttrium aluminum garnet (YAG; BTC of about 14 Wm⁻¹K⁻¹), hexagonal or crystalline Boron Nitride (BN; BTC>600 Wm⁻¹K⁻¹), graphene (BTC of about 400-2000 Wm⁻¹K⁻¹), diamond (BTC of about 600-2000 Wm⁻¹K⁻¹) combinations thereof, and the like. Without limitation, in some embodiments the first thermally conductive particles 109 are particles of nickel, aluminum oxide, boron nitride, silver, or a combination thereof.

The first thermally conductive particles 109 may be present in a homogeneous or heterogeneous distribution within the first matrix 107. In the case of a heterogeneous distribution, the first thermally conductive particles 109 may be distributed in a pattern within the first matrix 107, concentrated proximate the first surface 103, concentrated proximate the second surface 105, and/or concentrated proximate a center region of the core 101. In further embodiments the concentration of first thermally conductive particles 109 may vary (e.g., in a gradient) from the first surface 103 to the second surface 105. For example, the concentration of the first thermally conductive particles 109 may be relatively high proximate the first surface 103, and may become progressively lower moving towards the second surface 105. Conversely, the concentration of the first thermally conductive particles 109 may be relatively high proximate the second surface 105, and may become progressively lower moving towards the first surface. In some embodiments the first thermally conductive particles 109 are present in a homogenous or substantially homogenous distribution within the first matrix 107 of the core 101.

In embodiments and as shown in FIG. 1, the composite TIC 100 may be in the form of a sheet. In such instances the core 101 may be in the form of a layer having any suitable thickness, and the thickness may be adapted to suit a particular application. In some embodiments the thickness of the core 101 ranges from greater than 0 to about 10 millimeters (mm), such as from greater than 0 to about 5 mm, from greater than 0 to 2.5 mm, greater than 0 to about 1.25 mm, greater than 0 to about 0.5 mm, greater than 0 to about 0.2 mm, or even greater than 0 to about 0.1 mm Without limitation, in some embodiments the core 101 has a first thickness T1, the first skinning layer 111 has a second thickness T2, and (when used), the third skinning layer 117 has a third thickness T3, wherein T1>T2, T1>T3, and T2 and T3 are equal to or different from one another.

In the embodiment of FIG. 1 (and other FIGS), the first skinning layer 111 is depicted as being directly on the first surface 103 of the core 101. It should be understood that such illustrations are for the sake of example only, and that the first skinning layer 111 need not be directly on the first surface 103 of core 101. Indeed, the present disclosure envisions and encompasses embodiments in which one or more interlayers are present between the first surface 103 and the first skinning layer 111. For example, one or more thermally conductive interface layers (e.g., metal films) may be present between the first surface 103 of core 101 and the first skinning layer 111.

One function of the first skinning layer 111 may be to enhance thermal transfer of heat from a surface of an object (e.g., a heat generating component) into the other components of the composite TIM 100, such as but not limited to the core 101. The first skinning layer 111 may, therefore, include the same or different components as the core 101, but may be formulated to exhibit a low thermal interface resistance relative to the thermal interface resistance of the core 101. The first skinning layer 111 may also be configured to fill irregularities in the surface of an adherent, such as a surface of a heat generating component. For example, the first skinning layer 111 may configured such that is has viscosity, thermal conductivity, and/or thermal interface resistance that is/are lower than the corresponding properties of the core 101. The thermally conductive particles in the first skinning layer 111 may also be sized or otherwise configured such that they can infiltrate into and/or fill depressions, voids, cracks, etc. which may be present on or at the surface of an adherent. For example, the surface of an adherent may have micrometer or even nanometer scale surface roughness, and the thermally conductive particles of the first skinning layer 111 may be configured to occupy and/or fill in the variations on the surface of the adherent that are the result of that roughness.

The first skinning layer 111 includes a second matrix 113 and second thermally conductive particles 115. The second matrix 113 may be formed from the same or different materials as the first matrix 107. Accordingly, non-limiting examples of suitable materials that may be used as or in the second matrix 113 include the materials noted above as being suitable for use in the first matrix 107. Without limitation, in embodiments the first matrix 107 and second matrix 113 are both a b-stage matrix of one or more of the polymers noted above as being suitable for the first matrix 107. For example, in embodiments the first matrix 107 and the second matrix 113 are each a b-stage thermoset polymer composition, wherein the thermoset polymer composition has been lightly crosslinked (e.g., with a curing agent, heat, and/or pressure) prior to application to an object such as a surface of a heat generating component. And in specific non-limiting embodiments the first matrix 107 and the second matrix 113 are each a b-stage epoxy. In such embodiments the b-stage epoxy used in the first matrix 107 is the same as or different from the b-stage epoxy used in the second matrix 113. Non-limiting examples of suitable b-stage epoxies that can be used as or in the second matrix 113 include the b-stage epoxies noted above as being suitable for the first matrix 107. In embodiments, the first matrix 107 and the second matrix 113 are each a b-stage epoxy that has been cured to a crosslink density of about 5 to about 15% of the crosslink density of composition as fully cured. In such embodiments, the crosslink density of the b-stage epoxy used in the second matrix 113 may be different from the crosslink density of the first matrix 107. This may be done, for example, to control the viscosity of the first skinning layer 111 such that it is less than the viscosity of the core 101.

The second thermally conductive particles 115 are particles of one or more thermally conductive materials and, in particular, of one or a combination of thermally conductive materials that have a bulk thermal conductivity greater than the thermal conductivity of the second matrix 113. Thus, in some embodiments the second matrix 113 exhibits a thermal conductivity TC2 and the second thermally conductive particles 115 are formed from a material having a (bulk) thermal conductivity BTC2, wherein BTC2 is greater than TC2. In some embodiments, the second thermally conductive particles 115 comprise particles of at least one material that has a bulk thermal conductivity (BTC) greater than or equal to about 4 Wm⁻¹K⁻¹, such as greater than or equal to about 10 Wm⁻¹K⁻¹, greater than or equal to about 20 Wm⁻¹K⁻¹, or even greater than or equal to about 40 Wm⁻¹K⁻¹. As a result, the second thermally conductive particles 115 generally function to increase the thermal conductivity of the first skinning layer 111 above the thermal conductivity of the second matrix 113. The second thermally conductive particles 115 may also selected such that the first skinning layer 111 exhibits a thermal conductivity and thermal interface resistance that is less than the thermal conductivity and thermal interface resistance of the core 101.

Non-limiting examples of suitable materials that may be used as or in the second thermally conductive particles 115 include the materials noted above as being suitable for use as or in the first thermally conductive particles 109. Without limitation, in some embodiments the second thermally conductive particles 115 are particles of nickel, aluminum oxide, boron nitride, silver, or a combination thereof.

The second thermally conductive particles 115 may be present in a homogeneous or heterogeneous distribution within the first skinning layer 111. In the case of a heterogeneous distribution, the second thermally conductive particles 115 may be distributed in a pattern within the second matrix 113, concentrated proximate to one or more surfaces of the first skinning layer 111, and/or concentrated proximate a center region of the first skinning layer 111. In further embodiments the concentration of the second thermally conductive particles 115 may vary (e.g., in a gradient) across the thickness of the first skinning layer 111, e.g., from an upper to a lower surface thereof. Without limitation, in some embodiments the second thermally conductive particles 115 are present in a homogenous or substantially homogenous distribution within the second matrix 113.

In embodiments and as shown in FIG. 1, the first skinning layer 111 may be in the form of a conformal layer that is present on (e.g., directly on) the first surface 103 of the core 101. The first skinning layer 111 may also be configured to conform to the first surface 103 of the core 101, such that voids, gaps, etc. at the interface between the first skinning layer 111 and the first surface 103 are reduced, minimized, or even eliminated.

The first skinning layer 111 may have any suitable thickness, and the thickness of the first skinning layer 111 may be adapted to suit a particular application. In some embodiments the thickness of the first skinning layer is the same as or different from the thickness of the core 101, and ranges from greater than 0 to about 10 millimeters (mm), such as from greater than 0 to about 5 mm, from greater than 0 to 2.5 mm, from greater than 0 to about 1.25 mm, from greater than 0 to about 0.25 mm, or even from greater than 0 to about 0.1 mm Without limitation, in some embodiments the first skinning layer has a thickness T2 and the core 101 has a thickness T1, where T1 is greater than T2.

In embodiments the first skinning layer 111 is configured to exhibit physical properties that are different from that of the core 101. For example, the skinning layer 111 may have a viscosity V2 that is lower than the viscosity V1 of the core 101. The viscosity of the core 101 and the first skinning layer 111 may be adjusted in any suitable manner For example, the viscosity of the first skinning layer 111 may be adjusted by adjusting the degree to which the second matrix 113 is crosslinked, by adjusting the loading of the second thermally conductive particles in the second matrix 113, or a combination thereof. Generally, viscosity of the first skinning layer 111 may be lowered by reducing the crosslink density of the second matrix 113 and/or by reducing the amount of the second thermally conductive particles 115 in the second matrix 113.

As noted above and as illustrated in FIG. 1, in some embodiments the composite TIMs described herein may include an optional second skinning layer. The embodiment of FIG. 1 illustrates this concept, and shows the use of a second skinning layer 117 that is disposed under the second surface 105 of the core 101. That is, FIG. 1 depicts an embodiment wherein the second surface 105 of core 101 is directly on a second skinning layer 117. It should be understood that such illustration is for the sake of example only, and that the second surface 105 of core 101 need not be in direct contact with the second skinning layer 117. Indeed, the present disclosure envisions and encompasses embodiments in which the second skinning layer is not used, and/or in which one or more interlayers are present between the second surface 105 and the second skinning layer 117.

The second skinning layer 117 may be configured in the same or similar manner as the first skinning layer 111, and may function to facilitate thermal transfer between a (second) adherent and other elements of the composite TIM. This may be desirable, for example, when the composite TIM 100 is to be used between two or more articles such as between a heat sink and a heat generating component. Like the first skinning layer 111, the second skinning layer 117 may include the same or different components as the core 101, but may be formulated to exhibit a low thermal interface resistance, relative to the thermal interface resistance of the core 101. The second skinning layer 117 may also be configured such that it or its components can fill irregularities in the surface of an adherent. For example, the second skinning layer 117 may be configured such that is has viscosity, thermal conductivity, and/or thermal interface resistance that is/are lower than the corresponding properties of the core 101. The thermally conductive particles in the second skinning layer 117 may also be sized or otherwise configured such that they can infiltrate into and/or fill voids, cracks, etc., which may be present on or at the surface of an adherent, e.g., so as to reduce thermal interface resistance in the same manner as the first thermally conductive particles 111.

When used, the second skinning layer 117 includes a third matrix 119 and third thermally conductive particles 121. The third matrix 119 may be formed from the same or different materials as the first matrix 107 and/or the second matrix 113. Non-limiting examples of suitable materials that may be used as or in the third matrix 119 include the materials noted above as being suitable for use in the first matrix 107 and the second matrix 113. Without limitation, in embodiments the first matrix 107 and third matrix 119 are both a b-stage matrix of one or more of the polymers noted above as being suitable for the first matrix 107. For example, in embodiments the first matrix 107 and the third matrix 119 are each a b-stage thermoset polymer composition. And in specific non-limiting embodiments the first matrix 107 and the third matrix 119 are each a b-stage epoxy, such as the b-stage epoxies noted above as being suitable for the first matrix 107. In embodiments, the first matrix 107 and the third matrix 119 are each a b-stage epoxy that has been cured to a crosslink density of about 5 to about 15% of the crosslink density of composition as fully cured. In such embodiments, the crosslink density of the b-stage epoxy used in the third matrix 119 may be different from the crosslink density of the first matrix 107. This may be done, for example, to control the viscosity of the second skinning layer 117 such that it is less than the viscosity of the core 101.

The third thermally conductive particles 121 are particles of one or more thermally conductive materials and, in particular, of one or a combination of thermally conductive materials that have a bulk thermal conductivity greater than the thermal conductivity of the third matrix 119. Thus, in some embodiments the third matrix 119 may exhibit a thermal conductivity TC3 and the second thermally conductive particles 115 may be formed from a material having a (bulk) thermal conductivity BTC3, wherein BTC3 is greater than TC3. In some embodiments, the third thermally conductive particles 121 comprise particles of at least one material that has a bulk thermal conductivity (BTC) greater than or equal to about 4 Wm⁻¹K⁻¹, such as greater than or equal to about 10 Wm⁻¹K⁻¹, greater than or equal to about 20 Wm⁻¹K⁻¹, or even greater than or equal to about 40 Wm⁻¹K⁻¹. As a result, the third thermally conductive particles 121 generally function to increase the thermal conductivity of the second skinning layer 117 above the thermal conductivity of the third matrix 119. In some embodiments the third thermally conductive particles 121 are selected such that the second skinning layer 117 exhibits a thermal conductivity and thermal interface resistance that is less than the thermal conductivity and thermal interface resistance of the core 101.

Non-limiting examples of suitable materials that may be used as or in the third thermally conductive particles 121 include the materials noted above as being suitable for use as or in the first thermally conductive particles 109 and/or the second thermally conductive particles 115. Without limitation, in some embodiments the third thermally conductive particles 121 are particles of nickel, aluminum oxide, boron nitride, silver, or a combination thereof.

The third thermally conductive particles 121 may be present in a homogeneous or heterogeneous distribution within the second skinning layer 117. In the case of a heterogeneous distribution, the third thermally conductive particles 121 may be distributed in a pattern within the third matrix 119, concentrated proximate to one or more surfaces of the second skinning layer 117, and/or concentrated proximate a center region of the second skinning layer 117. In further embodiments the concentration of the third thermally conductive particles 121 may vary (e.g., in a gradient) across the thickness of the second skinning layer 117, e.g., from an upper to a lower surface thereof. Without limitation, in some embodiments the third thermally conductive particles 121 are present in a homogenous or substantially homogenous distribution within the third matrix 119.

In embodiments and as shown in FIG. 1, the second skinning layer 117 is in the form of a conformal layer that is present under (e.g., directly under) the second surface 105 of the core 101. In such embodiment the second skinning layer 117 may be configured to conform to the second surface 105 of the core 101, such that voids, gaps, etc. at the interface between the second skinning layer 117 and the second surface 105 are reduced, minimized, or even eliminated.

The second skinning layer 117 may have any suitable thickness, and the thickness of the second skinning layer 117 may be adapted to suit a particular application. In some embodiments the thickness of the second skinning layer 117 is the same as or different from the thickness of the core 101, and/or is the same as or different from the thickness of the first skinning layer 111. In embodiments, the thickness of the second skinning layer 117 ranges from greater than 0 to about 10 millimeters (mm), such as from greater than 0 to about 5 mm, from greater than 0 to 2.5 mm, from greater than 0 to about 1.25 mm, from greater than 0 to about 0.25 mm, or even from greater than 0 to about 0.1 mm Without limitation, in some embodiments the second skinning layer has a thickness T3, the first skinning layer 111 has a thickness T2, and the core 101 has a thickness T1, where T1 is greater than T3, and T2 and T3 the same or different from one another.

Like the first skinning layer 111, the second skinning layer 117 may be configured to exhibit physical properties that are different from that of the core 101. For example, the second skinning layer 117 may have a viscosity V3 that is lower than the viscosity V1 of the core 101, and which is the same or different from the viscosity V2 of the first skinning layer 111 (at the same temperature). The viscosity of the core 101 and the second skinning layer 117 may be adjusted in the same manner as discussed above with regard to the core 101 and the first skinning layer 111.

The particle size and/or particle size distribution of the thermally conductive particles used in the core 101 and the skinning layer(s) 111, 117 may affect the performance of the composite TIM 100, and/or the ability of the thermally conductive particles to be distributed within their respective matrixes. It may therefore be desirable to select thermally conductive particles for use in the core 101 and/or in the first/second skinning layers 111, 117 described herein based at least in part on their average particle size. For example, the use of relatively large thermally conductive particles in a matrix can enable the production of first composite that exhibits a relatively high thermal conductivity, but may also relatively high thermal interface resistance. In contrast, use of relatively small thermally conductive particles in a matrix can enable the production of a second composite that exhibits lower thermal conductivity than the first composite, but which also exhibits lower thermal interface resistance.

With the foregoing in mind, in some embodiments the composite TIMs described herein are configured such that the core 101 exhibits high thermal conductivity and thermal interface resistance relative to the first skinning layer 111 and, when used, the second skinning layer 117. In contrast, the first skinning layer 111 (and, when used, the second skinning layer 117) in such embodiments may be configured to exhibit a low thermal conductivity and a low thermal interface resistance, relative to the core 101.

Accordingly, in some embodiments the first thermally conductive particles 109 have a first average particle size, and the second thermally conductive particles 115 have a second average particle size, wherein the second average particle size is less than the first average particle size. For example, in some embodiments the first average particle size ranges from about 0.3 microns (μm) to about 75 μm, such as from about 0.3 μm to about 25 μm, or even about 0.3 μm to about 7 μm, and the second average particle size ranges from about 1 to about 200 nm, such as from about 5 to about 100 nm, or even from about 5 to about 85 nm.

In embodiments the first and second thermally conductive particles 109, 115, are particles of boron nitride, nickel, silver, and/or aluminum oxide, the first average particle size ranges from about 0.3 μm to about 75 μm, and the second average particle size ranges from about 5 to about 100 nm. In additional embodiments the first and second thermally conductive particles 109, 115, are particles of boron nitride, nickel, silver, and/or aluminum oxide, the first average particle size ranges from about 0.3 μm to about 7 μm, and the second average particle size ranges from about 5 to about 85 nm.

When a second skinning layer 117 is used, the third thermally conductive particles 121 may have a third average particle size, wherein the third average particle size is less than the first average particle size of the first thermally conductive particles 109 used in the core 101. In such embodiments, the third average particle size may be the same or different from the second average particle size of the second thermally conductive particles used in the first skinning layer 111. In embodiments the third average particle size is the same or substantially the same as the second average particle size.

As noted above the use of relatively large first thermally conductive particles 109 in the first matrix 107 can result in core 101 exhibiting a high thermal conductivity and high thermal interface resistance, relative to the first skinning layer 111 (and, when used, the second skinning layer 117). Similarly, use of relatively small second thermally conductive particles 115 in the first skinning layer 111 (and, when used, the second skinning layer 117) can result in the skinning layer(s) exhibiting a low thermal conductivity and low thermal interface resistance, relative to the core 101. Without wishing to be bound by theory, it is believed that the relatively small second thermally conductive particles can reduce thermal interface resistance by filling in irregularities (e.g., roughness) in a surface of an adherent to which the thermal interface material is coupled, and potentially by infiltrating into interstices in such a surface.

The shape of the thermally conductive particles used in the core 101 and skinning layers 111, 117 may also have an impact on manufacturing and/or performance of the composite TIMs described herein. Thus, it may be desirable to use thermally conductive particles that have a desired shape in the core 101 and/or skinning layers described herein. In that regard thermally conductive particles of any suitable shape may be used in the core and/or skinning layers. For example, the thermally conductive particles described herein may be in the form of spheres, spheroids, flakes, whiskers, platelets, cylinders, obloids, combinations thereof, and the like. Without limitation, in embodiments the thermally conductive particles comprise, consist essentially of, or consist of spherical thermally conductive particles, such as spherical metal, metal oxide or metal nitride particles, such as spherical nickel, silver, aluminum oxide, and/or boron nitride particles. Alternatively or additionally, in some embodiments the thermally conductive particles comprise, consist essentially of, or consist of flakes and/or whiskers, e.g., nickel, silver, aluminum oxide, and/or boron nitride particles.

The amount of thermally conductive particles used in the core 101 and skinning layers 111, 117 may vary widely. However, the amount of thermally conductive particles used in the core and the skinning layer(s) may impact various performance characteristics of the composite TIM 100. For example, as the amount of thermally conductive particles increases in the core 101 or skinning layer 111, 117, the thermal conductivity of such layer(s) will correspondingly increase. Use of excessive amounts of thermally conductive particles, however, may negatively affect the ability of the thermally conductive particles to be mixed into their respective matrices. Moreover as the amount of thermally conductive particles in the core and/or skinning layers increases, the viscosity of such layer(s) may increase. It may therefore be desirable to control the amount of thermally conductive particles used in core 101 and skinning layers 111, 117 to achieve a desired balance between thermal conductivity and other properties, such as viscosity. It should also be understood that the amount of thermally conductive particles that can be used in the core 101 and skinning layers 111, 117 may depend on various factors, such as the shape and composition of the thermally conductive particles, the composition of the matrix used in the core 101 and/or skinning layers 111, 117, whether or not any dispersing aids are used, etc.

With the foregoing in mind, the amount of first thermally conductive particles 109 used in the core 101 may vary widely. In some embodiments, the first thermally conductive particles 109 are present in the core 101 at an amount ranging from about 5 to about 90 volume % of the core 101, such as from about 10 to about 90 volume %, about 30 to about 90 volume %, about 50 to about 80 volume %, or even or even about 60 to about 80 volume %. Of course such ranges are for the sake of example only, and any suitable amount of first thermally conductive particles 109 may be used in the core 101.

Similarly, the amount of the second thermally conductive particles 115 used in the first skinning layer 111 may vary widely. In some embodiments, the second thermally conductive particles 111 are present in the first skinning layer 111 at an amount ranging from about 5 to about 80 volume percent of the core 101, such as from about 5 to about 70 volume %, about 5 to about 60 volume percent, or even about 20 to about 60 volume percent. Of course such ranges are for the sake of example only, and any suitable amount of second thermally conductive particles 115 may be used in the first skinning layer 111. In embodiments, the amount of second thermally conductive particles 115 is selected to achieve a first skinning layer 111 with a desired balance of thermal conductivity, thermal interface resistance, and viscosity.

When used, the second skinning layer 117 may be compositionally and/or structurally the same as or different from the first skinning layer 111. In embodiments the first and second skinning layers 111, 117 are compositionally the same (or substantially the same), and thus include the same type of matrix, the same type of thermally conductive particles (with the same or substantially the same average particle size), and the same or substantially the same amount of thermally conductive particles. In those or other embodiments, the second skinning layer 117 is structurally the same (or substantially the same) as the first skinning layer 111. That is, the second skinning layer 117 may have the same or substantially the same thickness as the first skinning layer 111, as well as the same or substantially the same physical properties (viscosity, modulus, thermal conductivity, thermal interface resistance, etc.) as the first skinning layer 111. In embodiments, the first and second skinning layers 111, 117 both include a b-stage polymer matrix (e.g., a b-stage epoxy) and thermally conductive particles selected from the group consisting of nickel particles, silver particles, boron nitride particles, aluminum oxide particles, or a combination thereof.

In other embodiments the composition of the second skinning layer 117 is different than the first skinning layer 111. In such embodiments, the third matrix 119 may differ from the second matrix 113, and/or the type, average particle size, and/or amount of the third thermally conductive particles 121 may differ from the type and/or amount of the second thermally conductive particles 115. Without limitation, in embodiments the first and second skinning layers 111, 117 are compositionally the same, and each include a b-stage epoxy matrix that contains thermally conductive nickel, silver, boron nitride, and/or aluminum oxide particles in an amount within the ranges set forth above for the second thermally conductive particles 115.

The core 101 and skinning layers 111, 117 may be configured such that the thermal conductivity of the composite TIM 100 is within a desired range. Without limitation, in embodiments the core 101 and skinning layers 111, 117 are configured such that the composite TIM 100 exhibits a thermal conductivity ranging from greater than 1 to about 20 Wm⁻¹K⁻¹, such as greater than 1 to about 10 Wm⁻¹K⁻¹, or even greater than 1 to about 7 Wm⁻¹K⁻¹.

The composite TIM 100 may also be configured such that has certain desired physical properties, such as tensile strength (post curing), shear strength (post curing), and drape (pre-curing). In embodiments, the composite TIM 100 is configured such that (post curing of the matrixes therein) it has a tensile strength greater than or equal to about 5 kilo pounds per square inch (KSI), such as greater than or equal to about 10 KSI.

In embodiments the composite TIM 100 may be configured to produce a tenacious bond with an adherent to which is coupled. The strength of the bond between the composite TIM 100 and an adherent may be characterized by the shear strength of the bond formed between the composite TIM 100 and an adherent, after the matrixes in the composite TIM have been cured. In that regard, in some embodiments the composite TIM 100 is configured such that when it is contacted with a surface of an adherent and cured, it produces a bond having a sheer strength that is greater than or equal to about 3 KSI, such as greater than or equal to about 5 KSI, or even greater than or equal to about 7 KSI. In some embodiments, the composite TIM 100 is configured to produce a bond with an adherent having a shear strength of about 5 to about 7 KSI.

The composite TIM 100 may also be configured such that it exhibits desirable drape characteristics, prior to curing of the matrixes therein. As used herein, the term “drape” refers to the ability of a material to bend about and conform to the surface of a curved article. The ability of the composite TIM 100 to drape on the surface of an adherend may be characterized by its bending radius, i.e., the minimum radius about which the composite TIM 100 may be bent without kinking, folding, or cracking. In embodiments, the composite TIM 100 is configured such that it has a bending radius (prior to curing) that is less than or equal to about one half of its total thickness, such as less than or equal to about one third or even one fourth of its total thickness. In embodiments, the total thickness of the composite TIM 100 may range from about 0.3 to about 30 mm, such as from about 0.3 to about 10 mm, or even from about 0.3 to about 5 mm In such instances, the bending radius of the composite TIM 100 may range from about 0.075 to about 15 mm, such as about 0.075 to about 10 mm, or even about 0.075 to about 7 mm.

In further embodiments the composite TIMs described herein may include one or more reinforcements. Such reinforcement may be used, for example, to provide or enhance the physical properties of one or more components of the composite TIM or the composite TIM as a whole. For example, a reinforcement may be used to enhance the physical properties of the core and/or skinning layers of the composited TIMs described herein, such as their modulus, tensile strength, bending radius or a combination thereof. Alternatively or additionally, a reinforcement may be applied in the composite TIMs described herein to facilitate adhesion and/or bonding of one component of the composite (e.g., the core) to another component of the composite (e.g., a skinning layer). In embodiments, one or more reinforcements is used and is configured to allow the composite TIM to bend about a radius that less than or equal to about one half, about one third, or even about one quarter of its total thickness without wrinkling.

Although any suitable type of reinforcement may be used, in embodiments the composite TIMs include one or more textile reinforcements, such as but not limited to a fabric reinforcements. Suitable fabric reinforcements that may be used in the composite TIMs described herein include woven and non-woven fabric reinforcements, which may be formed of or include any suitable type of natural or synthetic fibers. Examples of suitable fibers that may be used in such reinforcements include carbon fiber, glass fiber, aramid fibers, polyamide fibers, polyester fibers, combinations thereof, and the like.

Without limitation, in some embodiments at least one fabric reinforcement is used in the composite TIM's described herein, wherein the at least one fabric reinforcement is capable of stretching in one or more dimensions (e.g., a longitudinal or transverse dimension) by a desired amount prior to curing of composite TIM (or, more specifically, curing of the matrix(es) of the composite TIM that are impregnated into the reinforcement). n some embodiments at least one fabric reinforcement that has a stretch percentage in at least one dimension of at least about 10%, at least about 20%, at least about 30%, at least about 50%, or even at least about 60% or more, and the stretch percentage (SP) is calculated as follows: SP=(L2/(L1))*100%, where L1 is the unstretched length of the reinforcement, and L2 is the length of the reinforcement when stretched to its maximum (i.e., prior to tearing).

The degree to which a fabric reinforcement may stretch may depend on numerous factors, including the manner in which the fabric reinforcement is formed. With that in mind, in some embodiments at least one fabric reinforcement is used in the composite TIMs described herein, wherein the at least one fabric reinforcement is a slip-fiber fabric, a jersey weave fabric, a twill weave fabric, or the like. As used herein, the term “slip fiber fabric” refers to a fabric that includes composite strands containing discontinuous fibers that are held in contact with one another by bands or other techniques. A fabric may be made by arranging a plurality of the composite strands into a coaxial assembly, and securing the composite strands to one another with a hoop (of fiber or another material) around a the coaxial assembly, by wrapping a fiber or other material helically around the coaxial assembly, by stitching across the composite strands in the coaxial assembly, or by another technique. The discontinuous fibers in the composite strands can slip/slide relative to one another, allowing the fabric to stretch in one or more dimensions. Hence, such a fabric is called a “slip fiber” fabric.

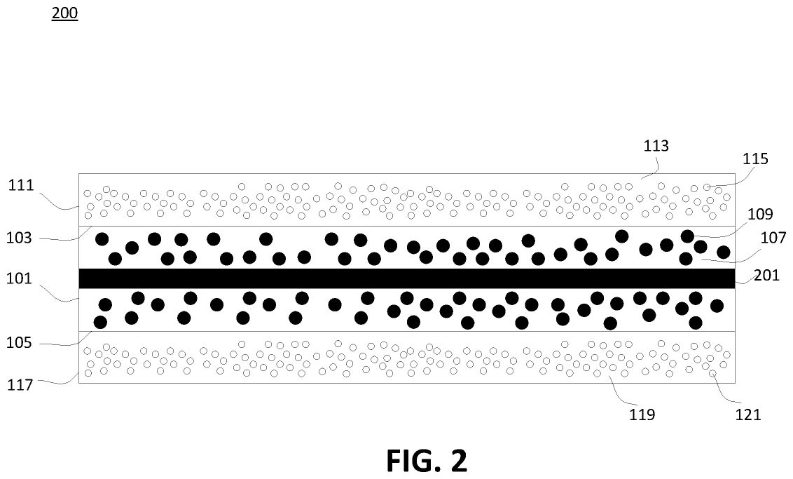

FIG. 2 depicts one example of a composite TIM including a reinforcement consistent with the present disclosure. As shown, the composite TIM 200 includes many of the same features of the composite TIM 100 described above in connection with FIG. 1. In the interest of brevity the description of such features is not reiterated. As further shown, the composite TIM 200 includes a reinforcement 201 that is disposed within the core 101. More particularly, in the embodiment of FIG. 2 the reinforcement 201 is disposed within a central region of core 101. The reinforcement 201 may be any suitable reinforcement, such as the reinforcements discussed above. Without limitation, the reinforcement 201 is a textile reinforcement, such as a twill weave, jersey weave, or slip fiber fabric that has a stretch percentage within the above mentioned ranges. In specific non-limiting embodiments, the reinforcement 201 is a slip fiber fabric that has a stretch percentage within the above mentioned ranges.

The reinforcement 201 may be disposed within the core 101 in any suitable manner. For example, the core 101 of FIG. 2 may be manufactured by mixing the first matrix 107 with first thermally conductive particles 109, and impregnating the mixture into the reinforcement 201 to form a prepreg. The position of the reinforcement 201 may be adjusted by pressing the reinforcement 201 into the matrix. Alternatively or additionally, an additional amount of the mixture of the first matrix 107 and first thermally conductive on or more sides of the prepreg. In the latter instance, the position of the reinforcement 201 within the core 101 may be determined by the overall thickness of the core 101, the amount of the mixture of the first matrix 107 and first thermally conductive particles 109 applied to either side of the prepreg, a combination thereof.

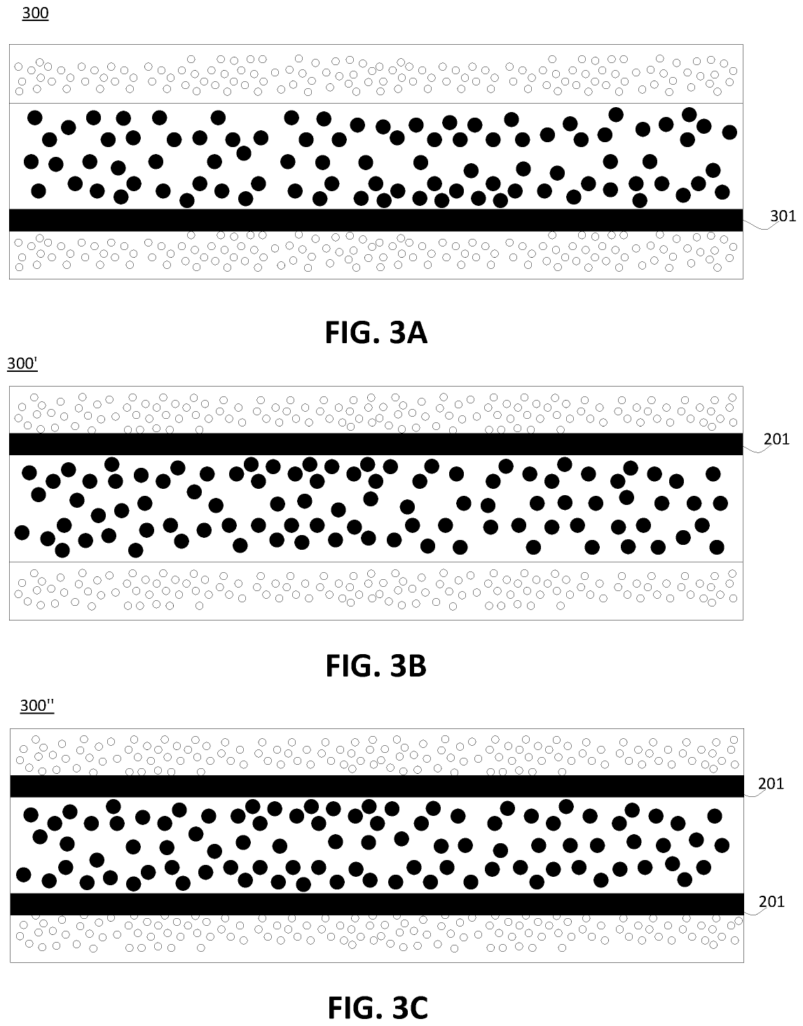

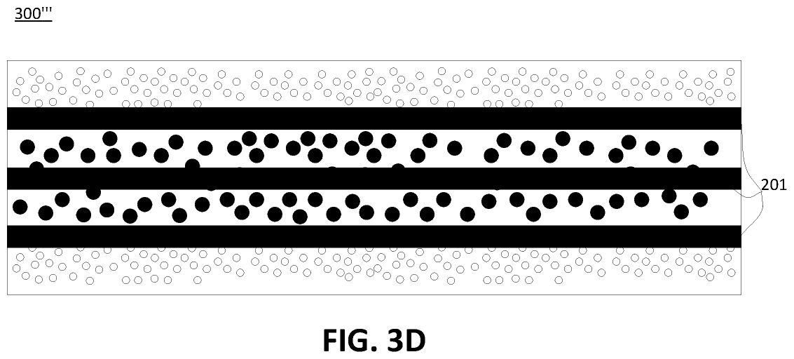

The position of the reinforcement 201 is not limited to the central region of the core 101 as shown in the embodiment of FIG. 2, but rather may be located at any suitable position within the composite TIM. For example, in some embodiments the composite TIMs described herein include at least one reinforcement at an interface between a core and a skinning layer. That concept is shown in FIGS. 3A and 3B, which depict composite TIMs 300, 300′ that include reinforcement 300 that is located at an interface between an upper or lower surface of the core 101 and a first or second skinning layer 111, 117.

Multiple reinforcements may be used in the composite TIMs described herein. That concept is illustrated in FIGS. 3C and 3D, which depict embodiments of composite TIMs 300″, 300′″ that include multiple reinforcements 201. In the embodiment of FIG. 3C, the composite TIM 300″ includes two reinforcements 201, wherein each reinforcement is located at an interface between the core 101 and a skinning layer (e.g., first or second skinning layer 111, 117). In the embodiment of FIG. 3D, the composite TIM 300′″ includes three reinforcements 201, wherein two of the reinforcements are located at an interface between the core 101 and a skinning layer, and one of the reinforcements is located within the thickness (e.g., proximate a central region) of the core 101.

While FIGS. 2 and 3A-3D depict embodiments in which a reinforcement is located at least partially within the core of a composite TIM, the use of reinforcements is not limited thereto. Indeed in some embodiments, the composite TIMs described herein include at least one reinforcement that is disposed fully or partially within a skinning layer. For example, the composite TIMs described herein may include one or more than one reinforcement that is disposed within a central region of the first and/or second skinning layers 111, 117, at an external (e.g., upper or lower) surface of the first and/or second skinning layers, or a combination thereof. Such reinforcements may be used independently or in conjunction with reinforcements that are disposed at least partially within the core 101 (i.e., reinforcements 201).

In embodiments where multiple reinforcements are used, the reinforcements may be the same as or different from one another. For example, in some embodiments the composite TIMs described herein include multiple reinforcements, wherein each reinforcement is selected from the types of reinforcements discussed above. In some embodiments, each of the reinforcements is a fabric having a stretch percentage within the foregoing ranges, such as jersey weave fabric, a twill weave fabric, a slip fiber fabric, or a combination thereof. Without limitation, in some embodiments the composite TIM includes a plurality (e.g., 2, 3, 4, or more) reinforcements, wherein each reinforcement is a twill weave fabric or a slip fiber fabric.

Another aspect of the present disclosure related to three dimensional (3D) thermal interface components (3D TICs). As will be discussed in detail, the 3D TICs are formed from or include a composite TIM consistent with the present disclosure, such as but not limited to the composite TIMs discussed in connection with FIGS. 1 to 3D. The 3D TICs described herein also include at least one convex surface. The at least one convex surface is designed to be placed in contact with and compressed by or against surface of an adherent, e.g., during the formation of a joint with the adherent. As the 3D TIC is compressed by or against the adherent, the at least one convex surface deforms to expel air from one or more spaces between the 3D TIC and the surface of the adherent. In that way, the at least one convex surface can reduce, limit, or even prevent the trapping of air between the 3D TIC and the surface of the adherent. Air bubbles at the interface between the 3D TIC and the surface of the adherent may, therefore, be limited or even eliminated. The negative impact of such air bubbles on thermal performance of the 3D TIC can therefore be reduced, minimized, or even eliminated.

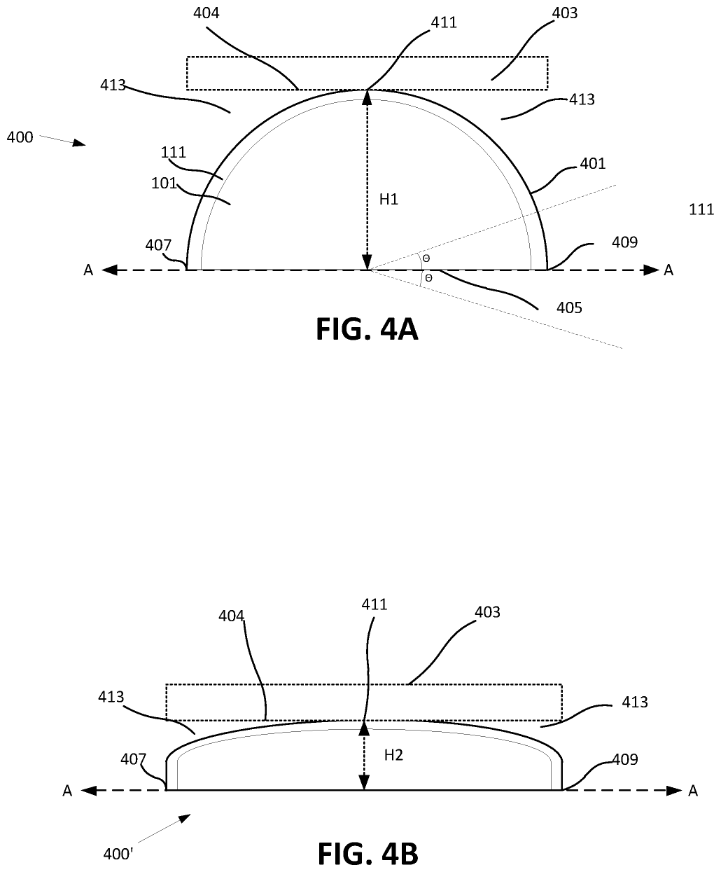

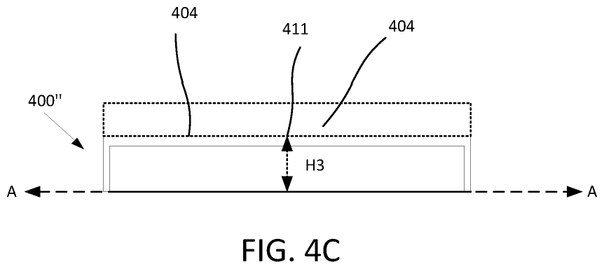

FIGS. 4A-4C are cross-sectional diagrams of one example of a 3D TIC consistent with the present disclosure. To facilitate understand of their operation and some of their advantages of the 3D TIC, FIGS. 4A-4C show the use of a 3D TIC consistent with the present disclosure as it is compressed by or against a surface of an adherent. It should be understood that such FIGS. merely depict an example of the application and deformation of a 3D TIC consistent with the present disclosure, and that the 3D TICs described herein need not be applied and/or used in the manner shown in those FIGS.

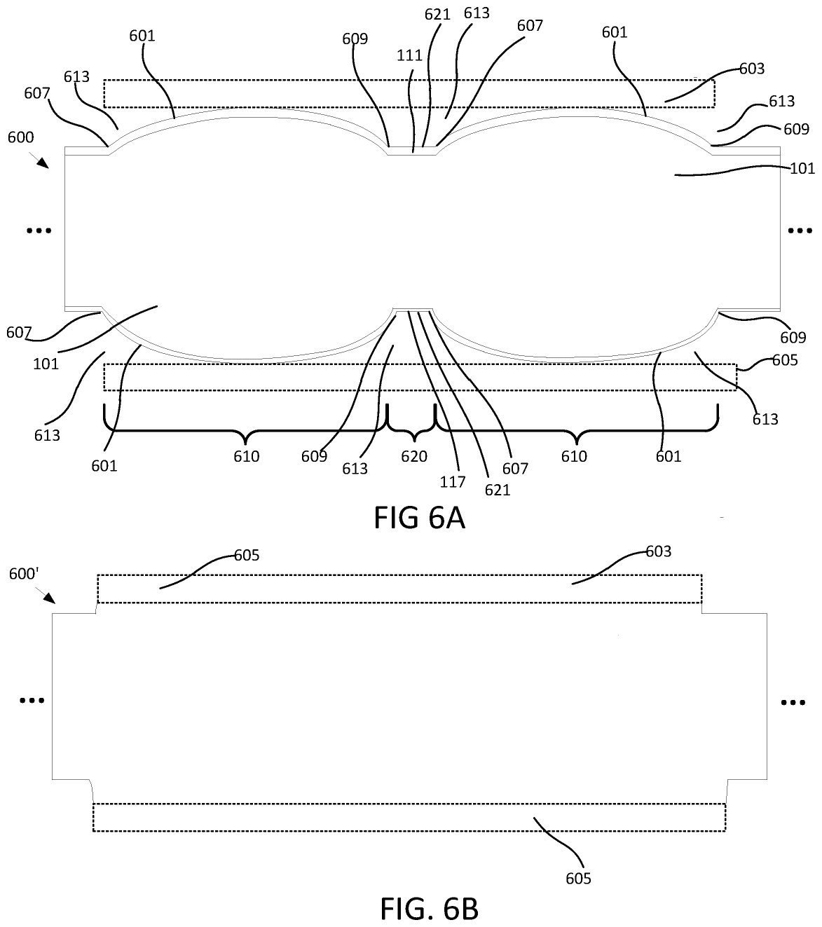

Moreover, FIGS. 4A-4C depict the use of a 3D TIC that has an initial cross-sectional profile in the shape of a half-sphere. It should be understood that the shape of 3D TICs described herein are not and, therefore, the 3D TICs described herein may have any suitable initial cross sectional profile provided the 3D TIC includes least one convex surface. In embodiments, the 3D TICs described herein have include one or more body regions that have an initial cross sectional profile in the shape of a half-sphere, a sphere, a ball, a cylinder, an ellipse, a rounded pyramid, a rounded 3D trapezoid, or an irregular geometric shape having one or a plurality of convex surfaces (e.g., ridges), and the like. The 3D TICs described herein may also have a cross sectional profile that includes a combination of such shapes. For example and as described later in conjunction with FIGS. 6A and 6B, the 3D TICs described herein may be a three dimensional shape that includes at least two body regions, wherein each body region has a cross sectional profile that is in one of the foregoing shapes, and are coupled to or joined to one another via an interconnection region. In such instances, each body region may have one or more convex surfaces.

In the embodiment of FIGS. 4A to 4C, 3D TIC 400 includes a core 101. Consistent with the foregoing discussion concerning composite TIM materials, the core 101 includes first matrix 107 and first thermally conductive particles 109, both of which are not shown in the interest of clarity. As shown in this embodiment, the core 101 has a semi-spherical shape, but as noted above the core 101 could have any suitable shape. In any case, the core 101 may at least partially define a first convex surface 401 of the 3D TIC 400. Alternatively or additionally, the first convex surface 401 may be at least partially defined by a first skinning layer 111, which is disposed as a conformal layer on the surface of the core 101. The first skinning layer 111 may include a second matrix 113 and second thermally conductive particles 115, as described previously in connection with composite TIM materials. Alternatively in some embodiments the first skinning layer 111 may be omitted, in which case a surface of the core 101 may define the first convex surface 401.

The 3D TIC 400 is generally configured to couple with one or more adherends. For example and as shown in FIGS. 4A-4C, the first convex surface 401 may be configured to come into contact with a first adherend 403 (e.g., a surface of a heat generating component). The 3D TIC further includes a bottom surface 405, which may be configured to couple to a second adherend (e.g., a contact surface of a heat sink, not shown). In this embodiment the bottom surface 405 is a flat or substantially flat surface, but it should be understood that the bottom surface 405 may have any suitable geometry. For example, in some embodiments the bottom surface 405 may at least partially define a second convex surface, which may mirror or differ from the first convex surface 401.

Although not shown, the bottom surface 405 may include, be formed of, or disposed on a second skinning layer 117 that includes a third matrix 119 and third thermally conductive particles 121. The type and nature of such components is discussed above with regard to the composite TIMs and is therefore not reiterated. Without limitation, in some embodiments the composition of the second skinning layer 117 on or in the bottom surface 405 is the same as the composition of the first skinning layer 111 on the first convex surface.

The 3D TIC 400 may be formed in any suitable manner In embodiments, 3D TIC 400 may be a pre-formed structure that is formed by molding, extruding or otherwise forming a mixture containing a matrix precursor and core particles used in the core 101 into a shape having first convex surface 401 and bottom surface 405, such as but not limited to the half-sphere shape of the core 101 of FIG. 4A. The resulting molded article may then be b-staged by partially curing the matrix precursor, so as to form the core 101 of FIG. 4A. Concurrent with or subsequent to the formation of the core 101, a first skinning layer 111 may be formed as a conformal layer on the first convex surface 401 core, such that an outer surface of the first skinning layer mimics or copies the surface features of the first convex surface 401. Consequently, the first convex surface 401 may be considered to be at least partially defined by the first skinning layer 111. Likewise, concurrent with or subsequent to the formation of core 400 and first skinning layer 111, a second skinning layer 117 may be formed as a conformal layer on the bottom surface 405.

The first skinning layer 111 may be formed or disposed on the first convex surface in any suitable manner For example, a composition containing a matrix precursor of the first skinning layer and second thermally conductive particles may be formed and deposited on the (previously formed) core 101. The resulting layer may then be b-staged by partially curing the matrix precursor, resulting in the formation of the first skinning layer 111). Alternatively, the first skinning layer 111 may be separately formed as a sheet containing a b-stage polymer matrix and second thermally conductive particles. In such instances, the sheet may be draped, molded, compressed, etc. over the first convex surface 401, resulting in the formation of 3D TIC 400. When used, the second skinning layer 117 may be formed and/or disposed on the bottom surface 405 in the same manner as the first skinning layer 111 is formed on the first convex surface 401. Still further, the 3D TIC 400 may be formed by introducing precursors of the core 101 and any skinning layers into a mold, and b-staging the precursors in the mold.

In still further embodiments, a 3D TIC may be formed by molding one or more of the composite TIMs described herein into a desired shape, e.g., using a compression mold, an extruder, calendaring, mechanical forming apparatus, by hand, or a combination thereof. For example, in some embodiments a composite TIM consistent with the present disclosure may be formed calendaring first, second, and (optionally) third mixtures into first, second and third sheets. The first mixture may contain a precursor of the first matrix and first thermally conductive particles, the second mixture may contain a precursor of the second matrix and second thermally conductive particles, and the optional third mixture may contain a precursor of the third matrix and third thermally conductive particles. The first sheet may be b-staged in the form of a sheet, or molded into a desired shape and then b-staged to form a core having a desired cross sectional profile. The second sheet may be applied to the core and b-staged thereon, or b-staged in the form of a sheet and then applied to the core to form the first skinning layer. When a second skinning layer is to be formed, the third mixture may be applied to the core and b-staged thereon, or b-staged in the form of a sheet and then applied to the core to form the second skinning layer. The resulting sheet may be used as-is, or may be molded or otherwise shaped in any suitable manner.

Returning to FIG. 4A, the 3D TIC 400 includes a first shoulder 407 and a second shoulder 409. In embodiments, the first and second shoulders 407, 409 are coplanar or substantially coplanar with one another. More specifically, in embodiments an axis A (parallel to the ground) may extend horizontally through the first shoulder 407 and/or the second shoulder 409. In instances where the first and second shoulders 407, 409 are coplanar, the axis A will extend through both shoulders, as shown in FIG. 4A. In instances where the first and second shoulders 407, 409 are substantially coplanar, the axis A may extend through only the first shoulder 407, and the second shoulder may be vertically offset from the axis A by an angle Θ of greater than 0 to plus or minus 15 degrees, as shown in FIG. 4A.

The first convex surface 401 is configured to contact with and be compressed by or against the surface 404 of an adherent, e.g., during the formation of a thermal joint with the adherent. As the 3D TIC is compressed, the at least one convex surface deforms to expel air from one or more spaces between the 3D TIC and the surface 404. That concept is shown in FIGS. 4A-4C. As shown in FIG. 4A, the first convex surface 401 extends from the first shoulder 407 to an inflection point 411 of the 3D TIC, and then back to the second shoulder 409. At or prior to initial contact with a surface 404 of the first adherent 403, the first convex surface has a peak height H1—which in this case is defined between the inflection point 411 and the opposing portion of the bottom surface 405. In use, the 3D TIC 400 may be brought into contact with the first adherent 403, such that surface 404 of the first adherent is generally parallel with the bottom surface 405 (and/or axis A), and at least a portion of the surface 404 contacts the first convex surface 401 at the inflection point 411, as shown in FIG. 4A. At that time a space 413 containing air or another gas may be present about the point(s) of contact between the first convex surface 401 and the surface 404 of the first adherent 403.

As shown in FIG. 4B, when the 3D TIC is compressed by or against the surface 404 it may deform to compressed 3D TIC 400′. More specifically, compression may cause the inflection point 411 to be displaced towards the bottom surface 405, and the regions of the first convex surface 401 adjacent the inflection point 411 to be displaced outwards. The space(s) 413 between the first convex surface 401 and the surface 403 may shrink as the air/gas therein is displaced as the 3D TIC 400 deforms. The peak height H1 may also be reduced to a peak height H2, as shown in in FIG. 4B.

As shown in FIG. 4C, additional compression by or against the surface 403 of the first adherent 404 may cause the compressed 3D TIC 400′ to further deform into a final 3D TIC 400″. More specifically, the additional compression may cause the inflection point 411 to further move towards the bottom surface 405 and to cause the regions of the first convex surface 401 adjacent the inflection point 411 to further displace outwards until all or substantially all of the surface of the first article is in contact with the upper surface of the 3D TIC 400. The final 3D TIC 400″ may have a peak height H3, which is less than or equal to H2. Air/gas within the space(s) 413 is also further displaced by the deformation of the 3D TIC, but is not trapped between the 3D TIC 400 and the first adherent—limiting or even eliminating the impact of air/gas pockets at the interface between the 3D TIC and the adherent 403 on the thermal performance of the 3D TIC.

Once the configuration shown in FIG. 4C is attained, the (b-stage) matrix/matrixes of the 3D TIC 400 may be fully cured, e.g., by the application of light, heat, pressure, or a combination thereof. Such curing can result in the formation of a structural bond between the 3D TIC 400 and the first article, wherein the shear strength of the bond is within the shear strength ranges described above in connection with a composite TIM.

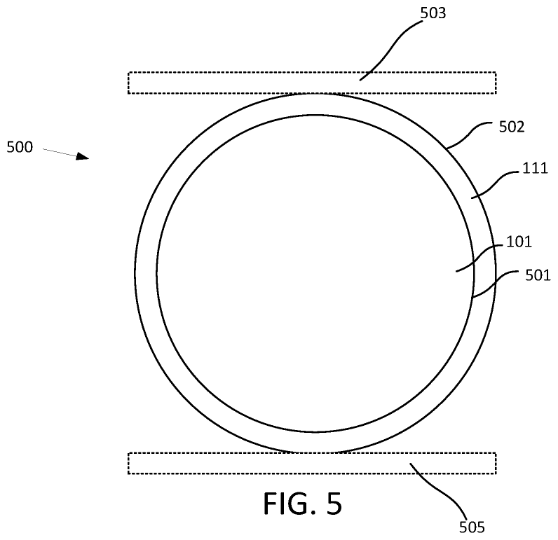

FIG. 5 is a cross sectional diagram of another example of a 3D TIC consistent with the present disclosure. As shown, 3D TIC 500 includes a core 101 and a first skinning layer 111, the type and nature of which are the same as described above in connection with a composite TIM. Unlike the embodiment of FIGS. 4A-4C, however, 3D TIC 500 has an initial cross sectional profile that is spherical. Accordingly, in this embodiment the core 101 has a first circumferential surface 501, on which the first skinning layer 111 is disposed. Notably, the skinning layer 111 conforms to the circumferential surface 501 without wrinkling, kinking, folding, or the like, and therefore defines a second circumferential surface 502.

Depending on the dimensions of the 3D TIC 500, one or more reinforcements (e.g. a fabric reinforcement such as a jersey weave fabric, twill weave fabric, or slip fiber fabric) may be included within the core 101, within the first skinning layer 111, and/or at least partially within the core 101 and first skinning layer 111. In embodiments, the reinforcement may function to enhance the bending radius of the core 101 and/or skinning layer 111, such that they may be formed to the desired shape without kinking or deforming in such a way as to trap air. In embodiments, one or more reinforcements are disposed at the interface between the core 101 and the first skinning layer 111 along the first circumferential surface 501.

As further shown in FIG. 5, to form a thermal joint the 3D TIC 500 may be disposed between a first adherent 503 (e.g., a heat generating component) and a second adherent 505 (e.g., a contact surface of a heat sink) and compressed. Compression of the 3D TIC 500 may cause the 3D TIC to compress in much the same manner as described above with regard to the 3D TIC 400, resulting in the expulsion/displacement of air from spaces between the second circumferential surface 502 and the first and second adherents 503, 505. Notably, deformation of the 3D TIC 500 may limit, hinder, or even prevent air from being trapped between the 3D TIC and the respective surfaces of the first and second adherents 503, 505.

FIG. 6A is a cross sectional diagram of another example of a 3D TIC consistent with the present disclosure. As shown, 3D TIC 600 includes multiple body regions 610 which are connected to one another via an interconnection region 620. Each body region 610 and the interconnection region 620 may include a core and one or more skinning layers, the nature and function of which is the same as described above in connection with other embodiments. That concept is shown in FIG. 6A, which illustrates each body region 610 and the interconnection region 620 of the 3D TIC 600 as including a core 101, a first skinning layer 111, and a second skinning layer 117. Consistent with the foregoing discussion, the second skinning layer 117 is optional and may be omitted.

The upper and lower surfaces of each body region 610 include first and second shoulders 607, 609, the nature, function, and location of which are the same as the first and second shoulders 407, 409 discussed previously. The upper and lower surfaces of each body region 610 also include a convex surface 601, the nature and function of which are the same as previously described in connection with FIGS. 4A-4C and 5.

The interconnection region 620 may be configured, in conjunction with a portion of adjacent convex surfaces 601 to form a channel for the removal of gas/air when 3D TIC 600 is used to form a thermal joint between two adherents. In that regard, the interface region may have a surface that is vertically offset relative to convex surfaces 601 that are adjacent to the interconnection region. More specifically and as shown in FIG. 6A, each interconnection region 620 may include a surface 621 that is vertically offset from convex surfaces 601 adjacent the interconnection region 620, such that the surface 621 is below the inflection point/peak height of each the adjacent convex surfaces 601. In some embodiments, the surface 621 is coplanar or substantially coplanar with the shoulders 607, 609 of two adjacent body regions 610.

To illustrate the ability of an interconnection region to facilitate the expulsion of air, reference is made to FIGS. 6A and 6B. As shown in FIG. 6A, a first adherent 603 may be contacted with the convex surface(s) 601 of the upper surface of each of the body regions 610, and a second adherent 605 may be contacted with the convex surface(s) 601 of the lower surface of each of the body regions 610. As shown, the first and second adherents initially contact the body regions at or proximate to an inflection point (not shown) along each convex surface 601, i.e., in much the same manner as described above in connection with FIGS. 4A-C. As discussed above, the interconnection region 620 includes a surface that is disposed below the inflection point of the adjacent convex surfaces 601 of each body region 620. As a result, spaces 613 containing gas/air may be present between the convex surfaces 601 and the surface 621 of the 3D TIC 600, and the corresponding surfaces of the first and second adherents 603, 605.

As the 3D TIC 600 is compressed by or against the first and second adherents 603, 605, the body portions 610 and/or interconnection portion 620 deform, e.g., in much the same manner as described above in connection with FIGS. 4A-4C. As the 3D TIC 600 deforms, the convex surfaces 601 and/or surface 621 move to displace air/gas from the spaces 613. Due to the position of the surface 621, a channel for the expulsion of air may be present as the 3D TIC 600 is initially compressed, but may gradually disappear as compression is applied. Notably, deformation of the 3d TIC 600 can result in the expulsion of all or nearly all of the air/gas from the spaces 613, thereby enhancing thermal contact between the 3D TIC and the corresponding surfaces of the adherents 603, 605. That concept is shown in FIG. 6B, which depicts a 3D TIC after compression against or between the first and second adherents 603, 605. Like the embodiment of FIG. 4C, once the 3D TIC 600 has reached the configuration should in FIG. 6B, the matrix/matrixes therein may be fully cured in any suitable manner In some embodiments, curing of the 3D TIC 600 results in a structural and thermal bond between it and the adherents 603, 605, wherein the bond has a shear strength within the above described ranges.

Consistent with the foregoing discussions, the 3D TICs described herein may include one or more reinforcement. In such instances the nature, function, and properties of the fabric reinforcement may be the same as described above with regard to the fabric reinforcement shown in and described in conjunction with FIGS. 2 and 3A-3D. For example, in some embodiments the 3D TICs may have structure consistent with FIGS. 4A, 5, and/or 6A, and may include one or more fabric reinforcements. In such instances the fabric reinforcement may be present within a core or skinning layer, and/or at an interface between a core and a skinning layer of such 3D TICs. In some embodiments, the 3D TICs described herein include at least one fabric reinforcement in a central region of a core thereof 400. In those or other embodiments, the 3D TICs described herein include at least one fabric reinforcement that is disposed at an interface between a core and a skinning layer thereof.

In embodiments, the 3D TICs described herein include a fabric reinforcement that is configured to stretch in one or more dimensions. Examples of such reinforcements include the twill weave and slip fiber fabric reinforcements discussed above. When used, such fabric reinforcements may permit the 3D TICs described herein to stretch in one or more dimensions, thereby allowing them to conform to a wide range of surfaces without the development of folds, kinks, or the like. As a result, the 3D TICs may be configured to conform even to a surface of an adherent that has a relatively high degree of curvature, while limiting or even avoiding air/gas entrapment at the interface between the adherent and the 3D TIC. This may enhance thermal performance by lowering the thermal interface resistance between the adherend and the surface of the 3D TIC. In instances where the 3D TICs include a skinning layer, the thermally conductive particles of the skinning layer may occupy/fill even small imperfections (e.g., micro scale and/or nano scale roughness) on the surface of the adherend, which may further reduce the thermal interface resistance at the interface between the 3D TIC and the adherend.

Adhesion of the 3D TIC to the article surface (e.g., after the matrix/matrices of the 3D TIC is/are cured) may also be improved, as displacing/eliminating gas/air entrapment may increase the contact area between the 3D TIC and the adherend at the interface thereof. This may be particularly true when the 3D TIC includes a skinning layer that has a relatively low viscosity and which contains relatively small thermally conductive particles, as the matrix and thermally conductive particles of the skinning layer may infiltrate the microstructure of the article surface, potentially increasing the bond strength between the article surface and the 3D TIC.

As will be appreciated the technologies of the present disclosure can offer several advantages, relative to previously known thermal solutions such as thermal greases, pastes, thermally conductive tapes, and the like. For example, the composite TIMs and 3D TIC's described here are relatively easy to produce, and may be used to create a precision thermal joint between adherends without the need for specialized and/or expensive equipment. In instances where the composite TIMs and 3D TIC's include b-stage matrixes, they may have an extended working life as such matrixes may require intentional action (e.g., application of a curing agent, light, elevated temperature, etc.) to cure. In embodiments, the composite TIMs and 3D TICs described herein can create a tenacious structural and thermal bond with an adherent, wherein the bond has high shear strength relative to many known thermal solutions. Moreover, the composite TIMs and 3d TICs may exhibit desirable properties, which allow them to conform to and/or drape over many surfaces, and even over surfaces with a significant degree of curvature. As a result, the composite TIMS and 3D TICs may be suitable for various challenging thermal applications, such as may be present in ultra-mobile/wearable devices, unmanned aerial vehicles (drones), highly curved surfaces, and composite structures.

### EXAMPLES

The following examples pertain to further embodiments consistent with the present disclosure:

Example 1: According to this example there is provided a composite thermal interface material, including: a core including a first surface and a second surface; and a first skinning layer on the first surface or the second surface; wherein: the core includes a first b-stage polymer matrix and first thermally conductive particles having a first average particle size; the first skinning layer includes a second b-stage polymer matrix and second thermally conductive particles having a second average particle size; and the second average particle size is smaller than the first average particle size.

Example 2: This example includes any or all of the features of example 1, wherein: the first b-stage polymer is a first b-stage epoxy; and the second b-stage polymer is a second b-stage epoxy that is same or different from the first b-stage epoxy.

Example 3: This example includes any or all of the features of any one of examples 1 and 2, and further includes a second skinning layer including a third b-stage polymer and third thermally conductive particles, wherein: the core is in the form of a layer; the first skinning layer is on the first surface of the core layer; the second skinning layer is on the second surface of the core layer; the second b-stage polymer is compositionally the same as or different from the third b-stage polymer; and the second thermally conductive particles are compositionally the same as or different from the third thermally conductive particles.

Example 4: This example includes any or all of the features of example 3, wherein the third thermally conductive particles have a third average particle size that is smaller than the first average particle size.

Example 5: This example includes any or all of the features of example 1, and further includes example 3, wherein: the first b-stage polymer is a first b-stage epoxy; the second b-stage polymer is a second b-stage epoxy; the third b-stage polymer is a third b-stage epoxy; and the first, second, and third b-stage epoxies are the same as or different from one another.

Example 6: This example includes any or all of the features of example 3, wherein: the second b-stage polymer is compositionally the same as the third b-stage polymer; and the second thermally conductive particles are compositionally the same as the third thermally conductive particles.

Example 7: This example includes any or all of the features of example 1, and further includes a fabric reinforcement.

Example 8: This example includes any or all of the features of example 7, wherein the fabric reinforcement is disposed within the core.

Example 9: This example includes any or all of the features of example 7, wherein the fabric reinforcement is disposed at an interface between the core and the first skinning layer.

Example 10: This example includes any or all of the features of example 3, and further includes at least one fabric reinforcement.

Example 11: This example includes any or all of the features of example 10, wherein the at least one fabric reinforcement is disposed within the core.

Example 12: This example includes any or all of the features of example 10, wherein the at least one fabric reinforcement includes a first fabric reinforcement at an interface between the core and the first skinning layer, and a second fabric reinforcement at an interface between the core and the second skinning layer.

Example 13: This example includes any or all of the features of example 10, wherein the at least one fabric reinforcement includes a slip fiber fabric, a twill weave fabric, or a combination thereof.

Example 14: This example includes any or all of the features of example 1, wherein: the first average particle size is in a range of about 0.3 to about 75 microns (μm); and the second average particle size is in a range of greater than 0 to less than 300 nanometers (nm).

Example 15: This example includes any or all of the features of example 14, wherein: the first average particle size is in a range of about 0.3 to about 7 μm; and the second average particle size is in a range of greater than 0 to less than or equal to about 80 nm.

Example 16: This example includes any or all of the features of example 15, wherein: the first average particle size is in a range of about 0.3 to about 75 microns (μm); and the second and third average particle sizes are each in a range of greater than 0 to less than 300 nanometers (nm).

Example17: This example includes any or all of the features of example 16, wherein: the first average particle size is in a range of about 0.3 to about 7 μm; and the second and third average particle sizes are each in a range of greater than 0 to less than or equal to about 80 nm.

Example 18: This example includes any or all of the features of example 1, wherein the first and second thermally conductive particles are each selected from the group consisting of nickel particles, silver particles, boron nitride particles, alumina particles, and combinations thereof.

Example 19: This example includes any or all of the features of example 3, wherein the first, second, and third thermally conductive particles are each selected from the group consisting of nickel particles, silver particles, boron nitride particles, alumina particles, carbon particles, graphite particles, graphene particles and combinations thereof.

Example 20: This example includes any or all of the features of example 1, wherein composite thermal interface material exhibits a thermal conductivity ranging from greater than or equal to about 1 to greater than or equal to about 10 watts per meter Kelvin (W/mK).

Example 21: This example includes any or all of the features of example 20, wherein composite thermal interface material exhibits a thermal conductivity ranging from greater than or equal to about 1 to greater than or equal to about 7 W/mK.

Example 22: This example includes any or all of the features of example 3, wherein composite thermal interface material exhibits a thermal conductivity ranging from greater than or equal to about 1 to greater than or equal to about 10 watts per meter Kelvin (W/mK).

Example 23: This example includes any or all of the features of example 11, wherein composite thermal interface material exhibits a thermal conductivity ranging from greater than or equal to about 1 to greater than or equal to about 7 W/mK.

Example 24: This example includes any or all of the features of examples 1 or 3, wherein: the first thermally conductive particles are present in the core in an amount ranging from greater than 0 to about 95% by volume; and the second thermally conductive particles are present in the first skinning layer in an amount ranging from greater than 0 to about 50% by volume.

Example 25: This example includes any or all of the features of example example 24, wherein the third thermally conductive particles are present in the second skinning layer in an amount ranging from greater than 0 to about 50% by volume.

Example 26: According to this example there is provided a three dimensional thermal interface component, including: at least one core including a first convex surface, the core including a first b-stage polymer matrix and first thermally conductive particles; wherein the thermal interface component is configured such that: when the first convex surface is contacted with a surface of a first adherend, a first space is present between the first convex surface and the surface of the first adherend; and when the first convex surface is compressed against the surface of the first adherend, the first convex surface deforms to expel air from the first space.

Example 27: This example includes any or all of the features of example 26, wherein: the at least one core includes a second convex surface; the second convex surface is configured such that when it is contacted with a surface of a second adherend, a second space is present between the second convex surface and the surface of the second article; and when the thermal interface component is compressed between the first adherend and the second adherend, the first convex surface deforms to expel air from the first space, and the second convex surface deforms to expel air from the second space.

Example 28: This example includes any or all of the features of example 26, and further includes a skinning layer on the at least one core.

Example 29: This example includes any or all of the features of example 28, wherein the skinning layer conforms to the first convex surface.

Example 30: This example includes any or all of the features of example 27, further including a skinning layer on the at least one core.

Example 31: This example includes any or all of the features of example 30, wherein the skinning layer conforms to both the first convex surface and the second convex surface.

Example 32: This example includes any or all of the features of example 28 or example 31, wherein the skinning layer includes a second b-stage polymer matrix and second thermally conductive particles.

Example 33: This example includes any or all of the features of example 32, wherein: the first thermally conductive particles have a first average particle size; and the second thermally conductive particles have a second average particle size that is smaller than the first average particle size.

Example 34: This example includes any or all of the features of example 33, wherein: the first average particle size is in a range of about 0.3 to about 75 microns (μm); and the second average particle size is in a range of greater than 0 to less than 300 nanometers (nm).

Example 35: This example includes any or all of the features of example 34, wherein: the first average particle size is in a range of about 0.3 to about 7 μm; and the second average particle size is in a range of greater than 0 to less than or equal to about 80 nm.

Example 36: This example includes any or all of the features of any one of examples 26 to 35, wherein the at least one core has a thermal conductivity ranging from greater than 1 to about 10 watts per meter/kelvin (W/mK).

Example 37: This example includes any or all of the features of example 36, wherein the at least one core has a thermal conductivity ranging from greater than 1 to about 7 W/mK.

Example 38: This example includes any or all of the features of example 26, wherein the first b-stage polymer matrix is a b-stage epoxy.

Example 39: This example includes any or all of the features of example 26, wherein the first thermally conductive particles are present in the at least one core at an amount ranging from greater than 0 to about 95 volume percent.

Example 40: This example includes any or all of the features of example 32, wherein the first b-stage polymer matrix is a b-stage epoxy, and the second b-stage polymer matrix is a b-stage epoxy.

Example 41: This example includes any or all of the features of example 32, wherein: the first thermally conductive particles are present in the core in an amount ranging from greater than 0 to about 95% by volume; and the second thermally conductive particles are present in the skinning layer in an amount ranging from greater than 0 to about 50% by volume.

Example 42: This example includes any or all of the features of example 26, further including a fabric reinforcement disposed within the at least one core.

Example 43: This example includes any or all of the features of example 42, wherein the fabric reinforcement includes a slip fiber fabric, a twill weave fabric, or a combination thereof.

Example 44: This example includes any or all of the features of example 32, further including a fabric reinforcement.

Example 45: This example includes any or all of the features of example 44, wherein the fabric reinforcement is disposed within the core.

Example 46: This example includes any or all of the features of example 44, wherein the fabric reinforcement is disposed at an interface between the core and the skinning layer.

Example 47: This example includes any or all of the features of any one of examples 44-46, wherein the fabric reinforcement includes a slip fiber fabric, a twill weave fabric, or a combination thereof.

Example 48: This example includes any or all of the features of example 26, wherein the first thermally conductive particles are selected from the group consisting of nickel particles, silver particles, boron nitride particles, alumina particles, carbon particles, graphite particles, graphene particles and combinations thereof.

Example 49: This example includes any or all of the features of example 32, wherein the first and second thermally conductive particles are each selected from the group consisting of nickel particles, silver particles, boron nitride particles, alumina particles, carbon particles, graphite particles, graphene particles and combinations thereof.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A three dimensional thermal interface component, comprising:
at least one core comprising a first convex surface, said core comprising a first b-stage polymer matrix and first thermally conductive particles;
wherein said thermal interface component is configured such that:
when the first convex surface is contacted with a surface of a first adherend, a first space is present between the first convex surface and the surface of the first adherend; and
when the first convex surface is compressed against the surface of the first adherend, the first convex surface deforms to expel air from the first space.

14. The thermal interface component of claim 13, wherein:
the at least one core comprises a second convex surface;
the second convex surface is configured such that when it is contacted with a surface of a second adherend, a second space is present between the second convex surface and the surface of the second article; and
when the thermal interface component is compressed between the first adherend and the second adherend, the first convex surface deforms to expel air from the first space, and the second convex surface deforms to expel air from the second space.

15. The thermal interface component of claim 13, further comprising a skinning layer on the at least one core, wherein said skinning layer conforms to the first convex surface.

16. The thermal interface component of claim 14, wherein said skinning layer conforms to both the first convex surface and the second convex surface.

17. The thermal interface component of claim 13, wherein the skinning layer comprises a second b-stage polymer matrix and second thermally conductive particles.

18. The thermal interface component of claim 17, wherein:
the first thermally conductive particles have a first average particle size; and
the second thermally conductive particles have a second average particle size that is smaller than the first average particle size.

19. The thermal interface component of claim 18, wherein:
the first average particle size is in a range of about 0.3 to about 7 μm; and
the second average particle size is in a range of greater than 0 to less than or equal to about 80 nm.

20. The thermal interface component of claim 13, wherein said first b-stage polymer matrix is a b-stage epoxy.

21. The thermal interface component of claim 13, further comprising a fabric reinforcement.

22. The thermal interface component of claim 21, wherein said fabric reinforcement comprises a slip fiber fabric, a twill weave fabric, or a combination thereof.

23. The thermal interface component of claim 21, wherein the fabric reinforcement is disposed in the core, at an interface between the core and the skinning layer, or a combination thereof.

24. The thermal interface component of claim 23, wherein the fabric reinforcement comprises a slip fiber fabric, a twill weave fabric, or a combination thereof.

25. The thermal interface component of claim 13, wherein the first thermally conductive particles are selected from the group consisting of nickel particles, silver particles, boron nitride particles, alumina particles, carbon particles, graphite particles, graphene particles and combinations thereof.
